(19) United States
(12) Patent Application Publication
(10) Pub. No.: US 2009/0059907 A1
(43) Pub. Date: Mar. 5, 2009

(54) System, method and device for docking station for communication device

(75) Inventors: Manoj Sindhwani, Oak Hill, VA (US); Brian Glinsman, Oak Hill, CA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/896,139

(22) Filed: Aug. 30, 2007

(51) Int. Cl. H04L 12/66

(52) U.S. Cl. 370/354

(57) ABSTRACT

A docking station provides fixed mobile convergence and includes a docking interface for a communication unit, a transceiver for a fixed packet network, and/or a telephone interface to a public switched telephone network (PSTN) telephone. The method includes detecting if the communication unit, fixed packet network, and/or PSTN telephone is connected. If the fixed packet network is available and the communication unit connected, a connection is established between the two in response to a call initiated/received at the communication unit; packets are transferred so that calls on the communication unit are conducted over the fixed packet network. If the PSTN telephone and the communication unit are connected, a connection is established between the two in response to a call initiated at the PSTN telephone or received at the communication unit; protocols are interworked to permit calls placed/received on the PSTN telephone to be conducted over the cellular network.

### TECHNICAL FIELD

The technical field relates in general to communication networks, and more specifically to fixed-mobile convergence.

### BACKGROUND

Many houses and businesses in the United States and Europe have very bad cellular coverage. This can lead to dissatisfaction with cellular service, and loss of minutes to a public switched telephone network (PSTN) which otherwise would have been expended on the cellular service. Many cellular telephone companies are considering alternatives to provide improved coverage at homes, hotels, businesses and other places.

One of the options being considered is to add WLAN (wireless local area network) to cellular telephone communication units, so that the communication units can be used in connection with WLAN routers at home to connect to the cellular network through broadband connections. Unfortunately, adding WLAN functionality to a communication unit can add cost and complexity, and perhaps more importantly can significantly reduce the life of the battery during active WLAN connections and whilst searching for possible WLAN connections, when the user may not even be in a WLAN coverage area.

Another option being considered is to use low power, small range base stations, commonly referred to as FEMTO cells, which are installed on a customer premise. This option is attractive because it does not implicate additional cost or complexity on the communication unit. However, FEMTO cells are not sufficiently inexpensive to have wide acceptance. In addition, FEMTO cells need much more effort in cell planning and interference avoidance, and can require management and maintenance by service providers.

### SUMMARY

Accordingly, one or more embodiments can provide a method, system, and/or device for providing fixed mobile convergence using a docking station for a cellular network communication unit on a fixed packet network, wherein the docking station can include a docking interface configured to connect to a communication unit and having a coupling for communicating with the communication unit; a transceiver operable to communicate with a fixed packet network, thereby to transmit and receive communications over at least a portion of the fixed packet network; and/or a telephone interface operable to connect to a public switched telephone network (PSTN) telephone or cordless telephone handset and communicate in accordance with a residential telephony network. It detects if a communication unit is connected at the docking interface; detects if the fixed packet network is available on the transceiver; and detects if the PSTN telephone is connected on the telephone interface. If the fixed packet network is available and if the communication unit is connected to the docking interface, it establishes, in response to a call initiated or received at the communication unit, a connection between the connected communication unit and the cellular network over the fixed packet network via the transceiver; and then transfers packets between packetized cellular communication signals at the communication unit and packet communication signals at the fixed packet network to permit calls placed or received on the communication unit to be conducted over the fixed packet network. If the PSTN telephone is connected and if the communication unit is connected to the docking interface, it establishes a connection between the connected communication unit and the PSTN telephone over the telephone interface in response to a call initiated at the PSTN telephone or a call received at the communication unit; and interworks protocols received from one of the PSTN telephone and the communication unit to the other to permit calls placed or received on the PSTN telephone to be conducted over the cellular network.

One or more embodiments can provide a method, system, and/or device for providing fixed mobile convergence. A docking interface is configured to connect to a communication unit and having a coupling for communicating with the communication unit. A transceiver is operable to communicate with a fixed packet network, thereby to transmit and receive communications over at least a portion of the fixed packet network. A processor is cooperatively operable with the transceiver and the docking interface. The processor is configured to detect if a communication unit is connected at the docking interface. Also, it is configured to detect if the fixed packet network is available on the transceiver. Further, if the fixed packet network is available and if the communication unit is connected to the docking interface, it establishes, in response to a call initiated or received at the communication unit, a connection between the connected communication unit and the cellular network over the fixed packet network via the transceiver; and then transfers packets between packetized cellular communication signals at the communication unit and packet communication signals at the fixed packet network to permit calls placed on the communication unit to be conducted over the fixed packet network.

One or more other embodiments can provide a method, system, device and/or computer-readable medium comprising instructions for execution by a computer, the instructions including a computer-implemented method for providing fixed mobile convergence using a computer-enabled docking station for a cellular network communication unit on a fixed packet network. The docking station can include a docking interface configured to connect to a communication unit and a coupling for communicating with the communication unit; a transceiver operable to communicate with a fixed packet network, thereby to transmit and receive communications over at least a portion of the fixed packet network; and/or a telephone interface operable to connect to a PSTN telephone or cordless telephone handset and to communicate in accordance with a residential telephony network. It detects if a communication unit is connected at the docking interface; and detects if the fixed packet network is available on the transceiver. If the fixed packet network is available and if the communication unit is connected to the docking interface, it establishes, in response to a call initiated or received at the communication unit, a connection between the connected communication unit and a cellular network over the fixed packet network via the transceiver; and then transfers packets between packetized cellular communication signals at the communication unit and packet communication signals at the fixed packet network to permit calls placed on the communication unit to be conducted over the fixed packet network.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the embodiments.

FIG. 1 is a diagram illustrating a simplified and representative environment associated with a docking station;

FIG. 2 is a block diagram illustrating portions of a docking station;

FIG. 3 is a block diagram illustrating portions of another docking station;

FIG. 4 is a block diagram illustrating portions of a further docking station;

FIG. 5 is a state diagram illustrating modes of the docking station;

FIG. 6 is a flow chart illustrating a procedure of docking a communication unit;

FIG. 7 is a flow chart illustrating an outgoing call procedure; and

FIG. 8 is a flow chart illustrating an incoming call procedure.

### DETAILED DESCRIPTION

In overview, the present disclosure concerns fixed-mobile convergence involving cellular communication networks, fixed packet networks, and/or public switched telephone networks (PSTN). Cellular communication networks support wireless communications systems to/from devices or units, often referred to as communication units, such as cellular telephones or two-way radios and the like, typically having mobile operating capability, and can be associated with a cellular communication system such as an enterprise network, a cellular Radio Access Network, a third generation cellular system, or the like, usually in connection with a subscription for a particular user; such communication systems may further provide services such as voice and data communications services. Fixed packet networks can be referred to as packet networks, for example broadband networks, or voice over packet (VOP) networks such as may be associated with networks supporting voice communication between wireless and/or wire line devices; such communication networks may provide additional services such as data communications, e-mail, web browsing, and/or video services. PSTN can be a circuit-switching interconnected voice-oriented public telephone networks, also sometimes referred to as Plain Old Telephone Service (POTS), typically providing calls between subscriber equipment such as telephones, utilizing telephony. As can be appreciated, in the designation “fixed mobile convergence,” “mobile” generally refers to the cellular communication aspects whereas “fixed” generally refers to the fixed packet network and/or PSTN aspects. More particularly, various inventive concepts and principles are embodied in systems, devices, and methods therein for providing fixed mobile convergence using a docking station.

The instant disclosure is provided to further explain in an enabling fashion the best modes of performing one or more embodiments. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring principles and concepts, further discussion of such software and ICs, if any, will be limited to the essentials with respect to the principles and concepts used by the exemplary embodiments.

As further discussed herein below, various inventive principles and combinations thereof are advantageously employed to expand access to telephones at the customer premises, and to avoid adding cost, complexity, and power consumption to the cellular telephone, as well as to avoid adding additional expensive support devices to the customer premises. The solution proposed herein provides methods, systems, and devices using a docking station, which can dock for example a cellular telephone, which further can provide access to broadband (such as via WLAN, Ethernet, Bluetooth and/or other connection) on premises, such as a home or a business, from the cellular telephone, optionally with built-in hands-free capability, and optionally with cordless, DECT (digital enhanced cordless technologies) and/or Bluetooth-based or similar handsets.

Further in accordance with exemplary embodiments, the docking station can include a standard based (such as USB (universal serial bus) or Ethernet) or proprietary interface to a communication unit. The docking station can be connected to a fixed packet network such as broadband, via a built-in DSL (digital subscriber line), cable, or FIOS (fiber optic service) modem, or be connected to a router or broadband modem through network access technology, e.g., Ethernet, Moca (multimedia over coax), HomePlug, HomePNA, WLAN, Bluetooth, or the like, and variants and evolutions thereof. When a communication unit such as a cellular telephone is attached to the docking station, the cellular telephone can sense the availability of a broadband connection, and be connected to the cellular network through a fixed packet network. Such connections can be provided utilizing fixed mobile convergence (FMC) protocols such as UMA (unlicensed mobile access), SIP-based (session initiation protocol), third generation protocols such as IMS (UP multimedia subsystem), and the like, as may be provided from time-to-time.

According to an embodiment, for example, the docking station can include an ability to present itself as a handset/hands-free device to the communication unit, which can include an ability to hook up hands-free devices using, e.g., a wired headset, USB, Bluetooth headset or Bluetooth hands-free device. One of these mechanisms can be used to redirect audio from the communication unit to the docking station for incoming and outgoing calls and to provide the ability to make and answer calls. In another embodiment, the docking station itself can include a keypad, handset and/or hands-free mechanism to answer/end telephone calls.

The docking station can also include built-in DECT, cordless, WLAN, and/or Bluetooth connections to connect to one or more cordless handsets. Optionally, use of these handsets can provide multi-line operation with the second line connected to PSTN or VoIP (voice over IP) gateways. The same mechanism can be used for enterprise users, small business, and other situations.

In one example, to make an outgoing call, a user may go “off-hook” and dial out using a keypad on the docking station, a home telephone handset connected to the residential telephony network, or a cordless handset connected to a built-in cordless base station. The docking station can use the docking interface with the communication unit connected via USB, Bluetooth, or wired connection (for example) to use the communication unit to initiate a call setup procedure over the cellular network. The docking station can redirect audio from the PSTN telephone to the communication unit using the hands-free mechanism which can be provided by the communication unit, and the like.

In another example, when an incoming call is received by a communication unit which is docked, that is connected to the docking interface, the communication unit can indicate the incoming call to the docking station using the docking interface (for example, USB, Bluetooth, or similar). The docking station can then ring the PSTN handsets at the residence using its telephone interface to the residential telephony network. A user can then pickup the call from one of the PSTN handsets, the built-in handset or hands-free mechanism. The audio from the communication unit can be routed to the docking station using the docking interface. The docking station can then redirect the audio to the PSTN telephone.

As will be further described herein, coverage at home can be increased without adding complexity to the handsets, using a mix of technology available at a reasonable cost.

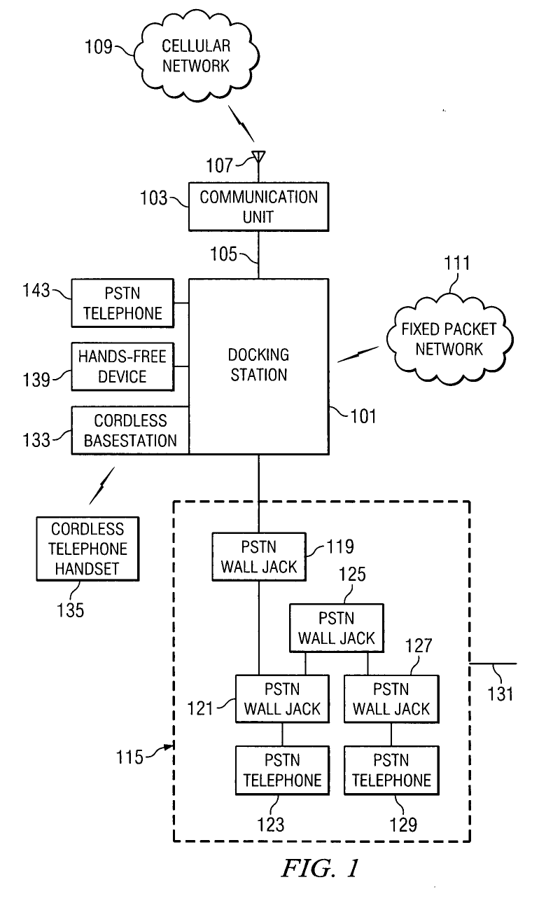

Referring now to FIG. 1, a diagram illustrating a simplified and representative environment associated with a docking station will be discussed and described. In this illustration, a docking station 101 can communicate with a communication unit 103 via a coupling 105. The communication unit has a transceiver 107 and is constructed to communicate with a cellular network 109 in ways which are well understood by those of skill in this area. The docking station 101 can communicate with a fixed packet network 111, and/or can connect to a local network portion 115 of a public switched telephone network (PSTN). The illustrated local network portion 115 of the PSTN will be well understood by one of skill in this area, and can include PSTN wall jacks 119, 121, 125, 127; PSTN telephones 123, 129 which connect to the PSTN wall jacks 121, 127; and a connection 131 to portions of the PSTN typically maintained by a telephone company. In this illustration, the docking station 101 is connected to the PSTN wall jack 119, to access the PSTN telephone.

In a mode when the communication unit 103 is docked at the docking station 105 and the fixed packet network 111 is available to the docking station 101, then a call which is initiated or received at the communication unit 103 is set up using the fixed packet network 111 instead of the cellular network 109. This can be desirable where, for example, the signal from the cellular network 109 is weak or non-existent at a residence or a business location.

Similarly, consider a mode where the communication unit 103 is docked at the docking station 105, the docking station 105 is connected to the local/on-premise portion 115 of the PSTN, and the PSTN telephone 123, 129 is connected to the local portion 115 of the PSTN. A call which is initiated or received at the PSTN telephone 123, 129 is directed over the cellular network 109 instead of the PSTN 131. Hence, a cellular network subscriber can expend minutes allocated by the cellular network. Alternatively, a call from the cellular network 109 received by the communication unit 103 when the docking station 105 is in this mode can be redirected to the local portion 115 of the PSTN, so that the PSTN telephones 123, 129 connected to the location portion 115 of the PSTN can be utilized. This alternative can be desirable so that the cellular network 109 is made accessible by other PSTN telephones 123, 129 in a building.

In the illustrated example, the docking station 101 includes a cordless base station 133 for use with one or more cordless telephone handsets 135. Thus, a user can initiate and/or receive telephone calls at the cordless telephone handset 135 from the docking station 101, over the cellular network 109 (if the communication unit 103 is docked). The cordless base station 133 can be built in to the docking station 101 for user convenience, so that a housing (not illustrated) of the docking station 101 also encompasses the cordless base station 133. Alternatively, the cordless base station 133 can be connected to the docking station 101 through a telephone line cord, for example. The base station 133 can communicate with cordless telephone handsets 135 in accordance with conventional techniques. As further described below, the docking station can interwork protocols from the PSTN telephone 143 on the docking station to the communication unit 103.

Also in this illustration, a PSTN telephone 143 is connected to the docking station 101, so that a user can initiate and/or receive telephone calls at the docking station 101 from the PSTN telephone 143 at the docking station 101, over the cellular network 109 (provided that the communication unit 103 is docked). A receiver (not illustrated) for the PSTN telephone 143 can be built in to the docking station 101 for user convenience, and can receive a PSTN telephone handset. Alternatively, the docking station 101 can connect to the PSTN telephone 143 through a telephone line cord, for example. As further described below, the docking station can interwork protocols from the cordless base station 133 on the docking station to the communication unit 103.

Further, in this illustration, a hands-free device 139 is connected to the docking station 101 so that a user can initiate and/or receive telephone calls at the docking station 101 in a hands free manner. Thus, a user can initiate and/or receive telephone calls at the hands-free device 139 from the docking station 101, over the cellular network 109 (during a situation that the communication unit 103 is docked). The docking station 101 can include an appropriate connection to the hands-free device 139, such as known techniques for a USB interface or Bluetooth wireless interface. Alternatively, the hands-free device 139 can be built in to the docking station, for example to be physically integrated into the docking station as distinguished from a freely removable hands-free unit. As further described below, the docking station can interwork protocols from the hand-free device 139 connected to the docking station, to the communication unit 103.

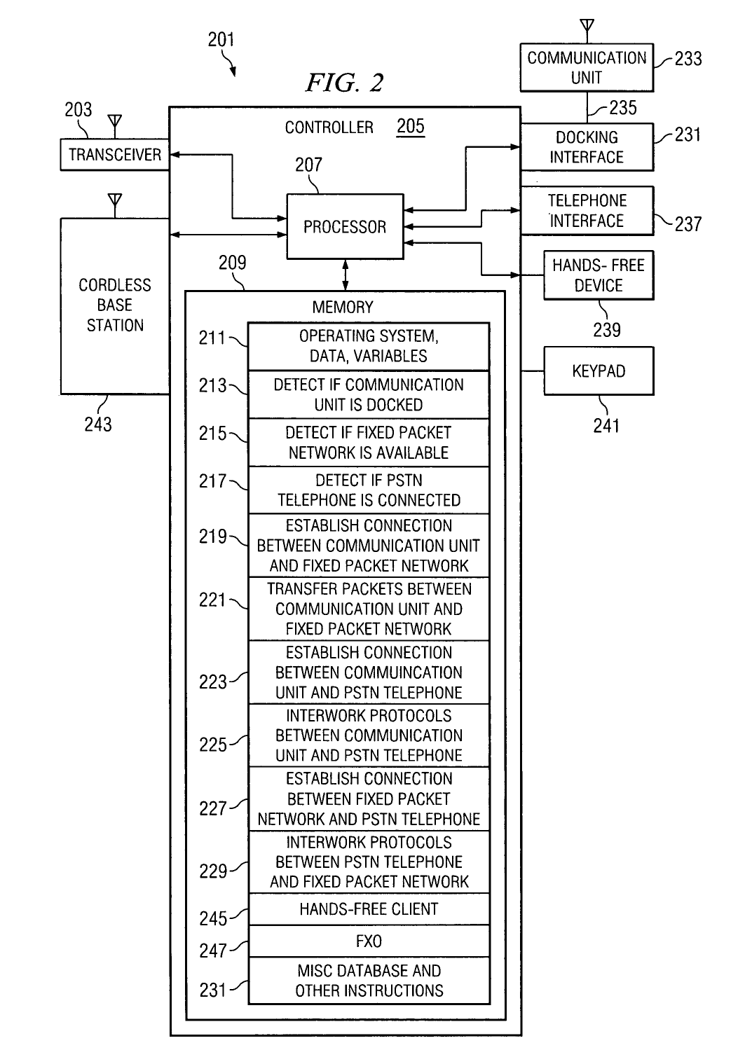

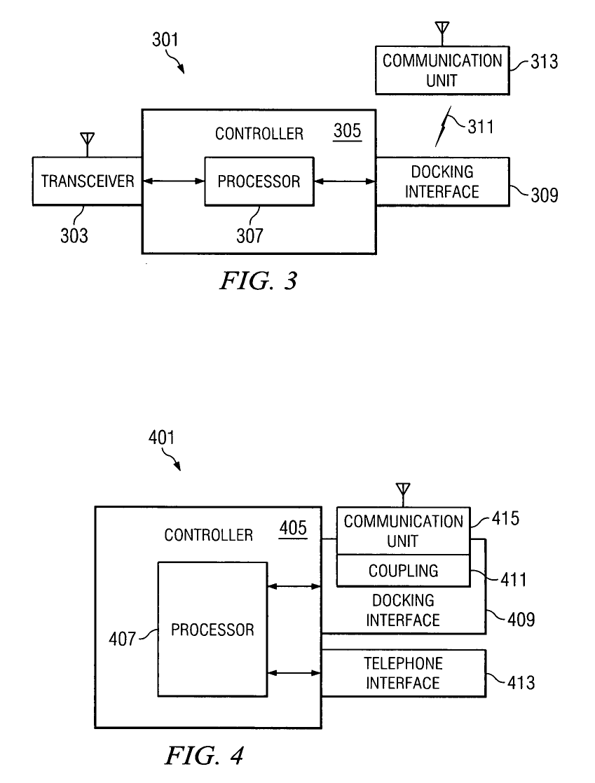

FIG. 2, FIG. 3 and FIG. 4 illustrate various embodiments of a docking station. FIG. 2 includes details of one embodiment, and FIG. 3 and FIG. 4 are simplified representations of different embodiments.

Referring now to FIG. 2, a block diagram illustrating portions of a docking station 201 will be discussed and described. The docking station 201 may include and one or more controllers 205. Included in the controller is a processor 207, and a memory 209. The docking station 201 can also include various other optional input/output devices such as a keypad 241, a display (not illustrated), a speaker (not illustrated), or a microphone (not illustrated).

The docking station 201 may be equipped with a receiver and transmitter or other communication port, represented here by transceiver 203, which can communicate over a wireless or wired connection with a fixed packet network, for example a broadband network, or a voice over packet (VOP) network, or a voice over IP (VoIP) network, for example in connection with Home Plug, HPNA (home phone networking alliance), Bluetooth, and/or other standards. The processor 207 can be connected to the transceiver 203 using components which are well understood and therefore will not be discussed herein.

The docking station 201 may include a docking interface 231 for connection to a communication unit 233. The processor 207 can be connected to the docking interface 231, and the docking interface 231 can be connected (wirelessly or with a direct electrical and/or mechanical connection) to the communication unit 233 to transmit/receive signals between the processor 027 and the communication unit 233 using a coupling 235 and other components, all of which are well understood and therefore will not be discussed herein. For example, the communication unit 233 can include a USB (universal serial bus) or other proprietary connection, and the docking interface 231 can include a coupling 235, for example USB, to provide both communication coupling and electrical coupling.

The docking station 201 may include a telephone interface 237, to be connected to a PSTN phone via a conventional connection such as a telephone jack, to receive/transmit signals between the processor 207 and the telephone interface 237 using components such as a telephone line cord, all of which are well understood and therefore will not be discussed herein.

The docking station 201 may also include a cordless base station 243, as discussed above. The processor 207 can be connected to the cordless base station 243 and receive signals from/transmit signals to the cordless base station 243 using components which are well understood, such as a telephone line cord, and will not be discussed further herein. (A telephone cord need not be used, if for example the cordless base station is built-in to the docking station 201.)

The docking station 201 may include a connection to a hands-free device 239, as discussed above. The processor 207 can be connected to the hands-free device 239 and receive signals from/transmit signals to the hands-free device 239 using components which are well understood and will not be discussed further herein.

The processor 207 may comprise one or more microprocessors and/or one or more digital signal processors. The memory 209 may be coupled to the processor 207 and may comprise a read-only memory (ROM), a random-access memory (RAM), a programmable ROM (PROM), an electrically erasable read-only memory (EEPROM), and/or a flash memory. The memory 209 may include multiple memory locations for storing, among other things, an operating system, data and variables 211 for programs executed by the processor 207; computer programs for causing the processor to operate in connection with various functions such detecting 213 if the communication unit is docked, detecting 215 if the fixed packet network is available, detecting 217 if the PSTN telephone is connected, establishing 219 a connection between the communication unit and the fixed packet network, transferring 221 packets between the communication unit and the fixed packet network, establishing 223 a connection between the communication unit and the PSTN telephone, interworking 225 protocols between the communication unit and the PSTN telephone, establishing 227 a connection between the fixed packet network and the PSTN telephone, interworking 229 protocols between the PSTN telephone and the fixed packet network, a hands-free client 245, FXO function 247, and/or other processing; and a database 231 for other information used by the processor 207. The computer programs may be stored, for example, in ROM or PROM and may direct the processor 207 in controlling the operation of the docking station 201. Each of these computer programs is discussed by way of example below.

The processor 207 may be programmed for detecting 213 whether or not the communication unit 233 is docked. For example, if the coupling 235 is wireless, the processor 207 can detect if the communication unit 233 is sufficiently in range to establish a wireless connection, and/or if the communication unit is mechanically connected and received at a cradle on the docking interface 231. If, on the other hand, the coupling 235 is wired, the processor 207 can detect if the communication unit 233 is electrically connected to the coupling 235 such that communication can be established over the coupling 235.

The processor 207 may be programmed for detecting 215 whether or not the fixed packet network is available. For example, if a wireless connection to the fixed packet network is found, the processor 207 can detect if the transceiver 203 is wirelessly and operably connected to the fixed packet network so as to be able to communicate. If, on the other hand, the transceiver 203 includes a wired coupling such as Ethernet, MOCA and/or HPNA, the processor 207 can detect if the network is electrically connected to the transceiver 203 such that communication can be established over the transceiver 203.

The processor 207 may be programmed for detecting 217 if the PSTN telephone is connected. For example, the processor 207 can detect if the telephone interface 237 is connected to the PSTN, for example via a PSTN wall jack (see FIG. 1). Also, the processor 207 can detect if the telephone interface 237 is connected directly to a PSTN telephone, for example through a telephone line cord.

The processor 207 may be programmed for establishing 219 a connection between the communication unit 233 and the fixed packet network, in response to detecting a connection to the communication unit 233. The processor 207 and the communication unit 233 can jointly indicate their capabilities to each other, sometimes referred to as “exchanging” their functions. In this “connection,” the packets (or data) between the communication unit 233 and the fixed packet network flow from/to the coupling 235 connected to the communication unit 233 on the docking interface 235 via the docking station 201, then to/from the fixed packet network on the transceiver 203, so as to establish a real-time connection; more particularly to permit bi-directional communications of content between the communication unit 233 and the fixed packet network.

The processor 207 may be programmed for transferring 221 packets (e.g., bridging, routing, or switching) between the communication unit and the fixed packet network, once the connection is established. Cellular communication signals are typically received at/transmitted from the communication unit 233 in a packetized form which is well understood. The fixed packet network also transmits/receives communications in packets according to conventional techniques. The packets, which are packetized cellular communication signals can be transferred to/from the packets which are used on the fixed packet network, so that packets and signals can be effectively transmitted between the cellular network and the fixed packet network, in accordance with standard techniques. Generally, the communication unit 233 can include a GAN or UMA function, described above.

The processor 207 may be programmed for establishing 223 a connection between the communication unit and the PSTN telephone, in response to a call initiated at the PSTN telephone on the telephone interface 237 or a call received at the communication unit 233. The “connection” here indicates that the signals between the communication unit 233 and the PSTN telephone flow from/to the coupling 235 connected to the communication unit 233 on the docking interface 235 via the docking station 201, then to/from the PSTN telephone on the telephone interface 237, in some configurations over the local but not remote portion of the PSTN, so as to establish a real-time connection; more particularly to permit bi-directional communications of content between the communication unit 233 and the PSTN telephone; and even more particularly to permit voice communication (e.g., conversation), e-mail, text messaging, browsing, and the like.

The processor 207 may be programmed for interworking 225 protocols between the communication unit 233 and the PSTN telephone (for example, using conventional FXO/FXS 247 techniques), such that calls placed or received on the PSTN telephone on the telephone interface 237 can be conducted over the cellular network. For example, the processor 207 can detect when the PSTN telephone on the telephone interface 237 goes off-hook and generates a dial tone to the PSTN, and can collect digits from the PSTN telephone and provides the digits to the communication unit using a hands-free dialing mechanism, such as the illustrated hands-free client 245. Conventional technology can be used for interworking between PSTN protocols and protocols from the communication unit 233.

For a call received at the communication unit, the communication unit can indicate the incoming call using the hands-free mechanism. The docking station can then ring the PSTN telephone, generate caller id (if applicable), and indicate to the communication unit that the call is answered when the PSTN telephone is off hook.

The processor 207 also may be programmed using known techniques for establishing 227 a connection between the VoIP network and the PSTN telephone, in response to a call initiated or received at the PSTN telephone on the telephone interface 237. The “connection” indicates that the protocols between the PSTN telephone and the VoIP fixed packet network flow from/to the PSTN telephone on the telephone interface (which may or may not be on the local portion of the PSTN), via the docking station 201, then to/from the fixed packet network on the transceiver 203, so as to establish a real-time connection; more particularly to permit bi-directional communications of content between the PSTN telephone and the VoIP network; and even more particularly to permit voice communication (e.g., conversation).

The processor 207 may be programmed for interworking 229 protocols between the PSTN telephone and the VoIP network, to permit calls placed or received on the PSTN telephone to be conducted over the packet network. Conventional VoIP technology can be used for interworking between PSTN protocols and protocols from the fixed packet network on the transceiver 203.

Optionally, the docking station 201 may include a PSTN telephone interface (not illustrated), to be connected directly to a PSTN telephone (illustrated in FIG. 1) via a conventional connection, to receive/transmit signals between the processor 207 and the telephone interface 237 using components such as a telephone line cord, all of which are well understood and therefore will not be discussed herein. The docking station 201 can treat signals received from the PSTN telephone interface (for example, a PSTN telephone handset on the docking station 201) identically to signals received from the telephone interface 237 (for example, a PSTN telephone handset connected to the local portion of the PSTN network).

The user may invoke functions accessible through a user input device, represented here by the keypad 241. The user input device may comprise one or more of various known input devices, such as the illustrated keypad 241, a computer mouse, a touchpad, a touch screen, a trackball, and/or a keyboard.

It should be understood that various logical groupings of functions are described herein. Different realizations may omit one or more of these logical groupings. Likewise, in various realizations, functions may be grouped differently, combined, or augmented. Furthermore, variations can omit functions. For example, a variation of the docking station 201 can omit the cordless base station 243, the keypad 241, and/or the hands-free device 239; the docking station 201 can omit either the transceiver 203 or the telephone interface 237. The memory 209 can omit corresponding functions. For example, if a variation of the docking station 201 includes the docking interface 231 (which can connect via the communication unit 233 to the cellular network) and telephone interface 237 (which can connect to the PSTN) but omits the transceiver 203 (which connects to the fixed packet network), the memory 209 can omit the following: function which detects 215 if the fixed packet network is available, which establishes 217 a connection between the communication unit and fixed packet network, and which transfers 219 packets between the communication unit and the fixed packet network. Similar omissions can be made if, for example, the telephone interface 237 is omitted.

As another example, the docking interface 231 can include a cradle formatted to receive and hold the communication unit 233 as further described in connection with FIG. 4. Alternatively, the coupling can be wireless, as further described in connection with FIG. 3.

Referring now to FIG. 3, a block diagram illustrating portions of another docking station 301 will be discussed and described. The main difference in this example is that the docking station 301 includes a docking interface 309 to receive a communication unit 313 for communicating over a cellular network, and a transceiver 303 for connecting to a fixed packet network.

The docking station 301 may include and one or more controllers 305; the controller 305 can include a processor 307, and other portions which are like those discussed above but are omitted from this discussion for clarity.

The docking station 301 may be equipped with a receiver and transmitter or other communication port, represented here by transceiver 303, which can communicate over a wireless or wired connection with a fixed packet network. Also, the docking station 301 may include the docking interface 309 for connecting to the communication unit 313 via a coupling 311. In the illustrated embodiment, the coupling is wireless, for example, Bluetooth or other short-range wireless couplings. The communication unit 313 conveniently can be placed in the vicinity of the docking station 301 or on a fixed cradle incorporated into the docking interface 309.

Various functions discussed in connection with FIG. 2 are not repeated here. Also, some of the functions illustrated in FIG. 2 can be omitted as they may be unnecessary with the less-fully configured docking station 301.

Referring now to FIG. 4, a block diagram illustrating portions of a further docking station 401 will be discussed and described. The main difference in this example is that the docking station 401 includes a docking interface 409 to receive a communication unit 415 for communicating over a cellular network, and a telephone interface 413 for connecting to a PSTN telephone.

The docking station 401 may include and one or more controllers 405; the controller 405 can include a processor 407, and other portions which are like those discussed above but are omitted from this discussion for clarity.

The docking station 401 may be equipped with a telephone interface 413 which can connect to a PSTN telephone, either with or without a local (but not remote) portion of a PSTN, as previously described. Also, the docking station 401 may include the docking interface 409 for connecting to the communication unit 415 via a coupling 411. In the illustrated embodiment, the coupling is mechanical, such as via a cradle to receive the PSTN telephone and/or via a latch, and electrical, that is including an electrical connection such as USB.

Various functions discussed in connection with FIG. 2 are not repeated here. Also, some of the functions illustrated in FIG. 2 can be omitted as they may be unnecessary with the less-fully configured docking station 401.

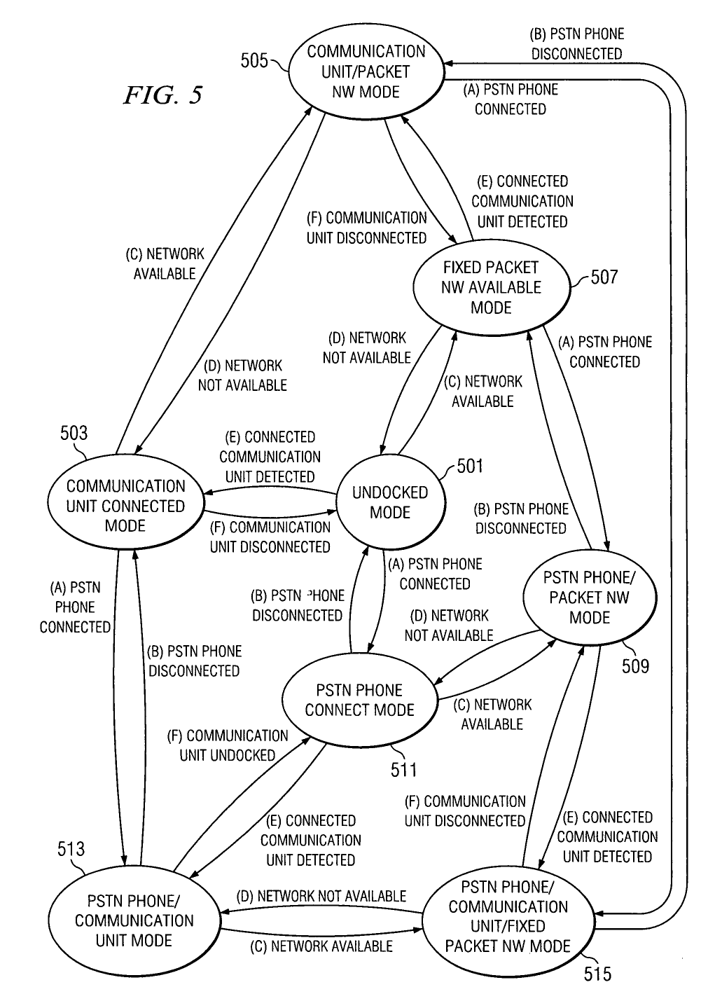

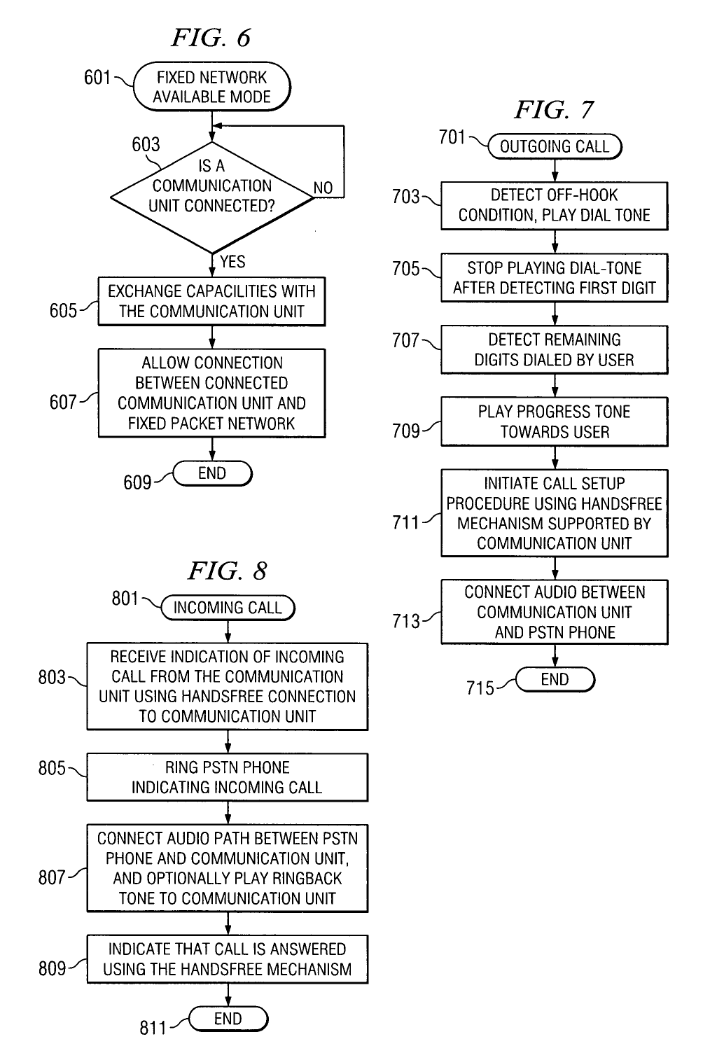

FIG. 5 provides a state diagram which is a convenient means to illustrate various modes in which the methods for providing fixed mobile convergence can operate. FIG. 6, FIG. 7, and FIG. 8 provide example flowcharts for procedures relating to connecting the communication unit to the fixed packet network, handling incoming calls, and handling outgoing calls to/from the communication unit on the fixed packet network. The state diagrams and procedures can advantageously be implemented on, for example, a processor of a controller, described in connection with FIG. 2 or other apparatus appropriately arranged.

Referring now to FIG. 5, a state diagram illustrating modes of the docking station will be discussed and described. Although various interfaces can be connected to a communication unit via the docking station, the use of the docking station can be reasonably simple, as illustrated by the simple modes (or states) described below. This illustration serves to illustrate various principles. Thus, it will be appreciated that an implementation need not be strictly state driven according to this illustration.

Generally, there can be three major classes of events, relating to the communication unit, the fixed packet network, and the PSTN telephone. The events include: PSTN telephone connected (A), PSTN telephone disconnected (B), fixed packet network available (C), fixed packet network not available (D), communication unit detected (E), and communication unit not detected (F). Some configurations can recognize only two classes of events, that is, the combination relating to the communication unit and PSTN telephone; or the combination relating to the communication unit and the fixed packet network.

These events result in the following possible states: undocked mode 501 (when the communication unit is undocked, the PSTN phone is not connected, and the fixed packet network is not detected); communication unit detected mode 503 (when the communication unit is detected, the PSTN phone is not connected, and the fixed packet network is not available); fixed packet network available mode 507 (when the communication unit is not detected, the PSTN phone is not connected, but the fixed packet network is available); PSTN phone connected mode 511 (when the communication unit is not detected, the PSTN phone is connected, and the fixed packet network is not available); PSTN phone connected/communication unit detected mode 513 (when the communication unit is detected, the PSTN phone is connected, but the fixed packet network is not available); communication unit detected/fixed packet network mode 505 (when the communication unit is detected, the PSTN phone is not connected, but the fixed packet network is available); PSTN phone connected/packet network mode 509 (when the communication unit is not detected, but the PSTN phone is connected and the fixed packet network is available); and PSTN phone connected/communication unit detected/fixed packet network mode 515 (when the PSTN phone is connected, the communication unit is detected, and the fixed packet network is available).

A process for fixed mobile convergence can take place when the communication unit is connected to the docking station and the docking station has a fixed packet network available. That is, communications can be provided using fixed mobile convergence in any of the following states: communication unit connected/fixed packet network mode 505, and PSTN phone connected/communication unit connected/fixed packet network mode 515.

Example flow charts for the process of docking, and for the process of handling an outgoing call and an incoming call during these modes are discussed below, respectively, in FIG. 6, FIG. 7, and FIG. 8. These can advantageously be implemented on a docking station, such as discussed and illustrated in connection with FIG. 2.

Referring now to FIG. 6, a flow chart illustrating a docking procedure 601 for connecting a communication unit and a fixed packet network will be discussed and described.

The procedure detects 603 whether a communication unit is connected. If the communication unit is connected, then optionally the communication unit can exchange 605 capabilities with the procedure 601 using known techniques. For example, the communication unit can transmit a communication identifying its functional capabilities, and the procedure 605 can transmit a communication identifying the functional capabilities of the device running the procedure 603. Such capabilities can indicate whether the communication unit can communicate over a fixed packet network.

Due to the exchange, the communication unit can determine that it has access to a packet network via the procedure 601. Then, the communication unit can enable or activate its FMC initiation procedures. Such FMC initiation procedures are known and an FMC mechanism is included in commercially available communication units. Thereby, the communication unit can be connected to the cellular network over the packet network using the communication units' FMC mechanism. The docking station can provide access to the fixed packet network and can use technologies such as bridging, routing, and the like, and extensions or variations thereof.

Thereafter, the procedure 601 can allow 607 a connection to occur between the connected communication unit and the fixed packet network. The mechanics of the connection can be transparent to the procedure 601, since the FMC mechanism provided in the communication unit handles the mechanics of the connection. The docking station can provide connectivity to the fixed packet network. The procedure for connecting the communication unit can then end 609.

Referring now to FIG. 7, a flow chart illustrating an outgoing call procedure 701 will be discussed and described. This procedure 701 assumes that the communication unit is connected to the cellular network over the packet network and the docking station is connected to a PSTN telephone, for example as illustrated in FIG. 6.

When the user goes off-hook on a telephone, the procedure detects 703 the off-hook condition, and plays the dial tone. Then, while the user dials a called party number, the procedure stops 705 playing the dial tone after detecting the first digit, and detects 707 the remaining digits being dialed by the user.

The procedure plays 709 a progress tone towards the user. Meanwhile, the procedure initiates 711 call set-up procedures with the communication unit in accordance with a hands-free protocol communicating with a hands-free mechanism provided in the communication unit. This will cause the communication unit to initiate call setup procedures using the cellular MSC utilizing the FMC connection over the fixed packet network. On the other hand, if the communication unit is already connected to the cellular network using the ordinary cellular connection, then the communication unit will use that connection to set up the call. Then, the procedure connects 713 audio between the communication unit and the PSTN telephone. The remainder of the connection can proceed transparently to the procedure 701. The procedure 701 can then end 715.

For example, the remote side of the connection can play a ringback tone toward the originating side. Since the audio from the communication unit is already being sent toward the PSTN telephone, the user will hear a ringback tone. Both originating side and remote side then have two-way audio once the remote user answers the call.

Referring now to FIG. 8, a flow chart illustrating an incoming call procedure 801 will be discussed and described. This procedure 801 assumes that the communication unit is connected to the cellular network over the packet network and the docking station is connected to the PSTN telephone, for example as illustrated in FIG. 6.

By way of background, assume that a remote user goes off-hook on a telephone and dials the telephone number of the communication unit. The cellular network MSC initiates the usual call setup procedure with the communication unit using the FMC connection, or a regular cellular network connection (similar to FIG. 7).

The procedure receives 803 an indication of an incoming call from the communication unit, with the communication unit using its hands-free mechanism. The procedure causes the PSTN telephone to ring 805, thereby indicating an incoming call. Then, the procedure connects 807 an audio path between the PSTN telephone and the communication unit, and optionally plays a ringback tone towards the communication unit.

The procedure detects that a local user answered the call at the PSTN telephone, and indicates 809 to the communication unit that the call is answered, using the hands-free protocol. The call can then proceed transparently to the procedure 801. For example, the communication unit can indicate to the cellular network MSC that the local user has answered the telephone call; and both the local user and the remote user can continue with a two-way audio connection. Then, the procedure 801 can end 811.

It should be noted that the term communication unit may be used interchangeably herein with subscriber unit, wireless subscriber unit, wireless subscriber device or the like. Each of these terms denotes a device ordinarily associated with a user and typically a wireless mobile device that may be used with a public cellular network, for example in accordance with a service agreement, or within a private network such as an enterprise network. Examples of such units include a cellular handset or device, a personal digital assistant, a personal assignment pad, and a personal computer equipped for wireless operation, or equivalents thereof.

The cellular networks and communication units of particular interest are those providing or facilitating voice communications services or data or messaging services over cellular wide area networks, such as conventional two way systems and devices, various cellular phone systems including analog and digital cellular, CDMA (code division multiple access) and variants thereof, 3G and 3.5G systems such as UMTS (Universal Mobile Telecommunication Service) systems, HSDPA (High Speed Downlink Packet Access) systems, and variants and evolutions thereof.

Furthermore, the fixed packet networks of interest include those that transmit information in packets, for example, those known as packet switching networks that transmit data in the form of packets, where messages can be divided into packets before transmission, the packets are transmitted, and the packets are routed over network infrastructure devices such as routers, transfers and gateways to a destination where the packets are recompiled into the message. Such networks include, by way of example, the Internet, intranets, local area networks (LAN), wireless LANs (WLAN), wide area networks (WAN), and others. Protocols supporting communication networks that utilize packets include one or more of various networking protocols, such as TCP/IP (Transmission Control Protocol/Internet Protocol), Ethernet, ATM (Asynchronous Transfer Mode), IEEE 802.11, UDP/UP (Universal Datagram Protocol/Universal Protocol), home plug, HPNA, MOCA, WiFi, and other wireless application protocols, and/or other protocol structures, and variants and evolutions thereof. Such networks can incorporate wireless communications capability and/or utilize wireline connections such as cable and/or a connector, or similar.

The term “PSTN” (public switched telephone network) is used herein to indicate the circuit-switching interconnected voice-oriented public telephone networks, both commercial and government-owned, also sometimes referred to as Plain Old Telephone Service (POTS). The PSTN sometimes includes a portion sometimes called “local network” typically within a building terminating at a network interface device (NID) or unit (NIU), as well as portions referred to herein as “remote” which are outside the building commencing at the NID or NIU and which are typically maintained by a telephone company and include a telephone company central office. The PSTN typically operates in accordance with well-understood principals of telephony. The designation “residential telephony network” is used herein to refer to the devices, wiring, and/or signaling protocols all used within the local network portion of the PSTN, such as a telephone jack, a PSTN telephone handset intended for use with a telephone jack, the wiring connecting the jacks to the NID or NIU, FXS (foreign exchange subscriber) and FXO (foreign exchange office) interfaces, telephony protocols for call setup and teardown, and related devices, wiring, and signaling protocols.

A device referred to herein as a “PSTN telephone” indicates a telephone handset device that operates in connection with FXO-FXS procedures, where the handset can be cordless or can be connected by a telephone line cord, and typically is connected to the PSTN at a telephone jack. A “cordless base station” as referred to herein is connected to the PSTN in lieu of a PSTN telephone, and typically communicates with the cordless telephone handset via radio waves, for example in accordance with DECT (digital enhanced cordless telecommunications), wireless LAN, Bluetooth™, and other digital or analog standards or proprietary protocols.

The term “transferring” is used herein to indicate translating data packets between the formats and transit principles of different media types, typically involving replacing the link layer and/or physical layer information of a packet formatted according to one network, with the corresponding link layer and/or physical layer information according to a different network. Transferring is used herein to indicate techniques generally referred to as bridging, routing, and switching.

The term “interworking” is used herein to indicate a process generally involving connecting networks that use different protocols and signaling. Interwork involves addressing not only the link layer and/or physical layer information of a packet of data, but also translating different application level signals and protocols.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A computer-implemented method for providing fixed mobile convergence using a docking station for a cellular network communication unit on a fixed packet network, wherein the docking station can include a docking interface configured to connect to a communication unit and having a coupling for communicating with the communication unit; a transceiver operable to communicate with a fixed packet network, thereby to transmit and receive communications over at least a portion of the fixed packet network; and/or a telephone interface operable to connect to a public switched telephone network (PSTN) telephone or cordless telephone handset and communicate in accordance with a residential telephony network, comprising:
detecting if a communication unit is connected at the docking interface;
detecting if the fixed packet network is available on the transceiver;
detecting if the PSTN telephone is connected on the telephone interface;
if the fixed packet network is available and if the communication unit is connected to the docking interface, establishing, in response to a call initiated or received at the communication unit, a connection between the connected communication unit and the cellular network over the fixed packet network via the transceiver; and then transferring packets between packetized cellular communication signals at the communication unit and packet communication signals at the fixed packet network to permit calls placed or received on the communication unit to be conducted over the fixed packet network; and
if the PSTN telephone is connected and if the communication unit is connected to the docking interface, establishing a connection between the connected communication unit and the PSTN telephone over the telephone interface in response to a call initiated at the PSTN telephone or a call received at the communication unit; and interworking protocols received from one of the PSTN telephone and the communication unit to the other to permit calls placed or received on the PSTN telephone to be conducted over the cellular network.

2. The method of claim 1, wherein the establishing of the call between the docking interface and the communication unit is directly over an electrical coupling.

3. The method of claim 1, wherein the establishing of the call between the docking interface and the communication unit is directly over a wireless short-range coupling in the docking interface.

4. The method of claim 1, further comprising, if the PSTN telephone is connected and if the fixed packet network is available, establishing a connection between the fixed packet network on the transceiver and the PSTN telephone on the telephone interface in response to a call initiated or received at the PSTN telephone; and interworking protocols received from one of the PSTN telephone and the fixed packet network to the other to permit calls placed or received on the PSTN telephone to be conducted over the fixed packet network.

5. The method of claim 1, wherein the communication unit is connected to the docking station in accordance with a hands-free session with the communication unit.

6. A docking station for a cellular network communication unit, for providing fixed mobile convergence, comprising:
a docking interface configured to connect to a communication unit and having a coupling for communicating with the communication unit;
a transceiver operable to communicate with a fixed packet network, thereby to transmit and receive communications over at least a portion of the fixed packet network; and
a processor cooperatively operable with the transceiver and the docking interface, the processor being configured to facilitate:
detecting if a communication unit is connected at the docking interface;
detecting if the fixed packet network is available on the transceiver; and
if the fixed packet network is available and if the communication unit is connected to the docking interface, establishing, in response to a call initiated or received at the communication unit, a connection between the connected communication unit and the cellular network over the fixed packet network via the transceiver; and then transferring packets between packetized cellular communication signals at the communication unit and packet communication signals at the fixed packet network to permit calls placed on the communication unit to be conducted over the fixed packet network.

7. The docking station of claim 6, wherein the docking interface physically engages with the communication unit and comprises a coupling communicating with the communication unit.

8. The docking station of claim 6, wherein the docking interface further includes an electrical coupling configured to provide power to the communication unit.

9. The docking station of claim 6, wherein the docking interface comprises a wireless short-range coupling configured to communicate with the communication unit.

10. The docking station of claim 6, further comprising a hands-free device configured to perform hands-free dialing to place a call on the communication unit.

11. The docking station of claim 10, wherein the hands-free device is built-in.

12. The docking station of claim 6, further comprising a telephone interface operable to connect to a public switched telephone network (PSTN) telephone or cordless telephone handset and communicate in accordance with a residential telephony network,
wherein the processor is further configured to facilitate detecting if the PSTN telephone is connected on the telephone interface; and if the PSTN telephone is connected and if the communication unit is connected to the docking interface, establishing a connection between the connected communication unit and the PSTN telephone over the telephone interface in response to a call initiated at the PSTN telephone or a call received at the communication unit; and interworking protocols received from one of the telephone and the communication unit to the other to permit calls placed on the PSTN telephone to be conducted over the cellular network.

13. The docking station of claim 12, wherein the processor is further configured for, if the PSTN telephone is connected and if the fixed packet network is available, establishing a connection between the fixed packet network on the transceiver and the PSTN telephone on the telephone interface in response to a call initiated or received at the PSTN telephone; and interworking protocols received from one of the PSTN telephone and the fixed packet network to the other to permit calls placed or received on the PSTN telephone to be conducted over the fixed packet network.

14. The docking station of claim 12, wherein the PSTN telephone placing the calls can be a cordless telephone handset, and the telephone interface can connect to the PSTN via a cordless telephone system for the cordless telephone handset.

15. The docking station of claim 6, wherein the communication unit is connected to the docking station in accordance with a hands-free session with the communication unit.

16. A computer-readable medium comprising instructions for execution by a computer, the instructions including a computer-implemented method for providing fixed mobile convergence using a computer-enabled docking station for a cellular network communication unit on a fixed packet network, wherein the docking station can include a docking interface configured to connect to a communication unit and a coupling for communicating with the communication unit; a transceiver operable to communicate with a fixed packet network, thereby to transmit and receive communications over at least a portion of the fixed packet network; and/or a telephone interface operable to connect to a PSTN telephone or cordless telephone handset and to communicate in accordance with a residential telephony network; the instructions for implementing:
detecting if a communication unit is connected at the docking interface;
detecting if the fixed packet network is available on the transceiver; and
if the fixed packet network is available and if the communication unit is connected to the docking interface, establishing, in response to a call initiated or received at the communication unit, a connection between the connected communication unit and a cellular network over the fixed packet network via the transceiver; and then transferring packets between packetized cellular communication signals at the communication unit and packet communication signals at the fixed packet network to permit calls placed on the communication unit to be conducted over the fixed packet network.

17. The computer-readable medium of claim 16, further comprising instructions for implementing:
if the PSTN telephone is connected and if the fixed packet network is available, establishing a connection between the fixed packet network on the transceiver and the PSTN telephone on the telephone interface in response to a call initiated or received at the PSTN telephone; and interworking protocols received from one of the PSTN telephone and the fixed packet network to the other to permit calls placed or received on the PSTN telephone to be conducted over the fixed packet network.

18. The computer-readable medium of claim 16, further comprising instructions for
detecting if the PSTN telephone is connected on the telephone interface; and
if the PSTN telephone is connected and if the communication unit is connected to the docking interface, establishing a connection between the connected communication unit and the PSTN telephone over the telephone interface in response to a call initiated at the PSTN telephone or a call received at the communication unit; and interworking protocols received from one of the telephone and the communication unit to the other to permit calls placed on the PSTN telephone to be conducted over the cellular network.

19. The computer-readable medium of claim 16, further comprising instructions for a hands-free client, wherein the communication unit can be connected at the docking interface by executing the hands-free client.

20. The computer-readable medium of claim 16, wherein the transferring instructions include collecting digits from the PSTN telephone, and detecting PSTN telephone conditions.
